(19) United States
(12) Patent Application Publication
(10) Pub. No.: US 2019/0198280 A1
(43) Pub. Date: Jun. 27, 2019

(54) Magnetron

(71) Applicant: Toshiba Hokuto Electronics Corporation, Asahikawa-shi, Hokkaido (JP)

(72) Inventor: Masatoshi Higashi, Hokkaido (JP)

(73) Assignee: Toshiba Hokuto Electronics Corporation, Asahikawa-shi, Hokkaido (JP)

(21) Appl. No.: 16/301,334

(22) PCT Filed: May 17, 2016
(86) PCT No.: PCT/JP2016/002413

§ 371 Date: Nov. 13, 2018

(51) Int. Cl. H01J 23/54; H01J 25/50; H01J 23/40

(52) U.S. Cl. CPC H01J 23/54; H01J 23/40; H01J 25/50

(57) ABSTRACT

To provide a magnetron capable of balancing cost reduction and effective suppression of high frequency components.

A choke 30 is formed as a separated part from an output side metal sealing body 7. A Cu-plated metal layer 7C is formed on the metal sealing body 7, and a Sn-plated metal layer 30F which is cheaper and has a lower melting point than the Cu-plated part is formed on the choke 30. Thereby, in a brazing process, the tightly-adhered part of the Cu-plated part on the metal sealing body 7 and the Sn-plated part on the choke 30 is melted and becomes Cu-Sn alloy, and the choke 30 is joined to the metal sealing body 7 as firm as the case of using brazing materials. Thus, plating costs and brazing costs can be reduced; it enables to balance cost reduction and effective suppression of high frequency components in comparison with conventional magnetrons.

### TECHNICAL FIELD

The present invention relates to a magnetron, and is suitably applicable to a continuous wave (CW) magnetron used for microwave heating equipment such as an electronic microwave oven.

### BACKGROUND ART

In general, magnetrons for electronic microwave ovens generate microwaves at 2450 MHz band. In this case, a high frequency component having an integer time of the frequency of a fundamental wave component is generated with the fundamental wave component. When the high frequency component is radiated from an output unit of a magnetron, it is propagated to a heating space in the magnetron with the fundamental wave component. Because high frequency components have shorter wavelengths and are difficult to be shielded, they are sometimes leaked to the outside and occur radio interference or the like; the limit value of leakage is set by law.

Therefore, conventional magnetrons are designed so that a choke groove is formed in an output unit to suppress arbitrary high frequency components by the choke groove (see for example Patent Document 1).

A choke groove is formed by a metal choke provided on an output unit (hereinafter referred to as choke). As conventional methods of providing this choke in an output unit, such methods are common that as shown in FIG. 5A, a choke 100 is press-formed integrally with a metal sealing body 101 of the output unit, and that as shown in FIG. 5B, a choke 102 prepared as a separated part is joined by a Ag—Cu brazing material (i.e. brazed) to a metal sealing body 103.

In magnetrons in which a choke and a metal sealing body are formed as separated parts, also there is that a plurality of chokes are joined to a metal sealing body to suppress arbitrary plural high frequency components, for example.

As materials for metal sealing bodies and chokes, cold-rolling steel sheets are used. Depending on cases, steal sheets made of SUS, 42 alloy, and Kovar (iron alloys) are used. For that, in general, Ni plating and Cu plating is applied to metal sealing bodies and chokes for suppression of released gas, brazeability, and improvement of corrosion resistance.

### PRIOR ART DOCUMENTS

### Patent Documents

[Patent Document 1]

Japanese Patent Application Laid-open Publication No. 2005-50572

### SUMMARY OF THE INVENTION

### Problems to be Solved by the Invention

By the way, when a choke and a metal sealing body are integrally press-formed, the number of parts and brazing materials can be reduced in comparison with the case of forming a choke as a separated part, thus costs can be reduced. On the other hand, considering processes, molding costs, precision of parts, etc., it cannot provide only one choke groove with pressing limitations. Furthermore, limitations come out also in the dimensions and precision of a choke groove depending on the material and sheet thickness.

Therefore, when it is wanted to provide plural choke grooves inside a metal sealing body to effectively suppress high frequency components generated from a magnetron and when it is wanted to provide a choke groove having the dimensions that cannot be made by integral molding, it has been needed to form a choke as a separated part and braze it to a metal sealing body.

In this case, it needs extra material costs, processing (pressing) costs, plating costs, and brazing costs for the choke as a separated part, in comparison with the case of integrally-forming a choke and a metal sealing body. Assuming that a choke is a usual pressed part, as costs for the choke, plating costs and brazing costs are considerably larger than the material costs and processing costs.

As the above, in conventional magnetrons, when a choke is formed as a separated part and is brazed to a metal sealing body, there has been a problem that plating costs and brazing costs are costly; it leads to cost increase of a magnetron.

The present invention has done to solve the above problem, and aiming to provide a magnetron capable of balancing cost reduction and effective suppression of high frequency components, in comparison with conventional magnetrons.

### Means for Solving the Problems

In order to achieve the above purpose, a magnetron of the present invention is characterized in that, a magnetron provided with a cylindrical metal choke for suppressing harmonics inside a cylindrical metal sealing body provided on the output unit side of an anode cylinder comprises a first metal layer plated on the inner wall of the metal sealing body; and a second metal layer plated on the surface of the metal choke and different in melting point from the first metal layer, and an alloy layer of the first metal layer and the second metal layer is formed at the joined part of the metal sealing body and metal choke.

In a brazing process of the magnetron, the choke is joined to the metal sealing body by that the tightly-adhered part of the plated choke and plated metal sealing body is melted and becomes an alloy.

### Advantageous Effect of the Invention

According to the present invention, in a brazing process of a magnetron, the tightly-adhered part of a plated choke and a plated metal sealing body is melted and becomes an alloy; it can be used in place of a brazing material. Thereby, although a choke is formed as a separated part from a metal sealing body, costs of brazing materials can be especially more reduced than conventional magnetrons. It enables to balance cost reduction and effective suppression of high frequency components in comparison with conventional magnetrons.

### BRIEF DESCRIPTION OF THE DRAWINGS

FIG. 1 is a longitudinal sectional view of an overall magnetron according to the present invention.

FIG. 2 is a schematic sectional view showing the configuration of an output unit of a magnetron according to the present invention.

FIG. 3 is a schematic sectional view showing the configuration of an output unit of another embodiment of magnetron according to the present invention.

FIG. 4 is a side view showing the configuration of a choke of another embodiment of magnetron according to the present invention.

FIGS. 5(A) and 5(B) are schematic sectional views showing the configuration of an output unit of a conventional magnetron.

### EMBODIMENTS FOR CARRYING OUT THE INVENTION

With reference to the accompanying drawings, an embodiment of magnetron according to the present invention will be described. Note that, the following embodiments are simply examples, and the present invention is not only limited to these.

### [1. Configuration of Magnetron]

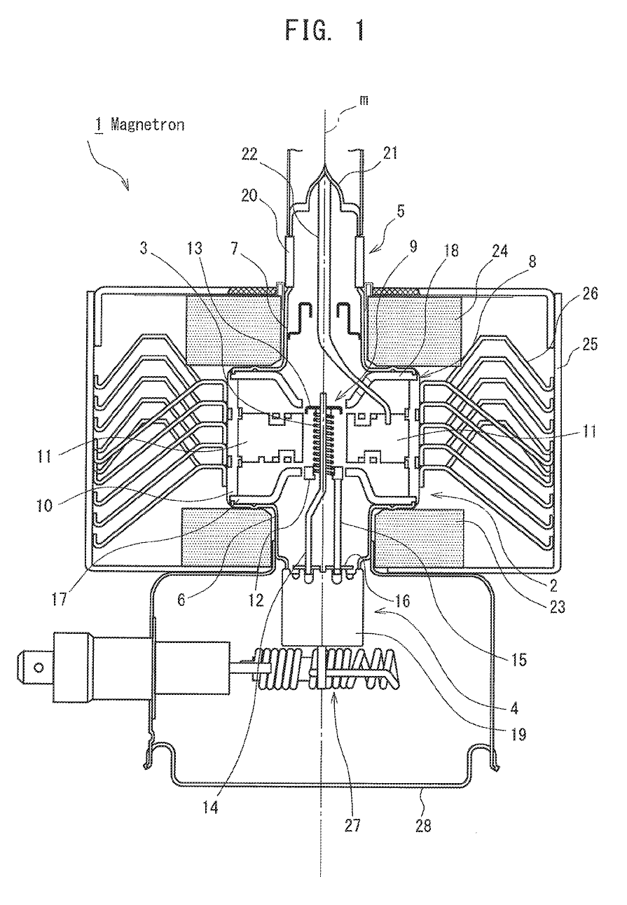

First, a first embodiment will be described. FIG. 1 is a longitudinal sectional view showing an overall outline of a magnetron 1 of this embodiment. The magnetron 1 is a magnetron for an electronic microwave oven that generates microwaves at 2450 MHz band. The magnetron 1 has an oscillating unit 2 that generates microwaves at 2450 MHz band, an input unit 4 for supplying electric power to a cathode 3 positioned at the center of the oscillating unit 2, and an output unit 5 for taking microwaves oscillated from the oscillating unit 2 out of the tube (magnetron 1). The oscillating unit 2, input unit 4, and output unit 5 are provided along a tube axis m being the central axis of the magnetron 1. That is, the input unit 4 is provided on one end side of the oscillating unit 2 in the tube axis direction (the lower side in FIG. 1), and the output unit 5 is provided on the other end side (the upper side in FIG. 1).

The input unit 4 and output unit 5 are joined to the oscillating unit 2 via a metal sealing body 6 on the input side and a metal sealing body 7 on the output side respectively in a vacuum airtight state.

The oscillating unit 2 has an anode part 8 and a cathode part 9. The anode part 8 has an anode cylinder 10 and a plurality of (e.g., ten) vanes 11. The anode cylinder 10 is cylindrically formed, and is disposed so that its central axis passes through the tube axis m being the central axis of the magnetron 1.

Each of the vanes 11 is formed into a sheet, and they are disposed inside the anode cylinder 10 centering around the tube axis m. The outside end part of each vane 11 is joined to the inner peripheral surface of the anode cylinder 10, and the inside end part is a free end. A cylindrical space enclosed with the free ends of the plural vanes 11 is an electron operating space.

The cathode part 9 has the cathode 3, two end hats 12, 13, and two support rods 14, 15. The cathode 3 is a spiral cathode, and is provided on the tube axis m in the electron operating space. The end hats 12, 13 are fixed to the input side end part (lower end part) of the cathode 3 and the output side end part (upper end part) of that respectively to prevent electrons from emitting.

The cathode 3 is further connected to the support rods 14, 15 via the end hats 12, 13 respectively. Two support rods 14, 15 are led out of the tube via an intermediate plate 16.

In the oscillating unit 2, a pair of pole pieces 17, 18 is provided facing each other inside the input side end part (lower end part) of the anode cylinder 10 and the output side end part (upper end part) of that respectively, as interposing a space between the end hats 12 and 13.

The input side pole piece 17 in which a through hole is provided at its center part is formed in a funnel shape wider toward the input side (downward) centering the through hole, and also the output side pole piece 18 in which a through hole is provided at its center part is formed in a funnel shape wider toward the output side (upward). The pole pieces 17, 18 are disposed so that the tube axis m passes through those center of the through hole respectively.

Furthermore, to the outer peripheral part of the input side pole piece 17, the upper end part of the almost-cylindrical metal sealing body 6 extending in the direction of the tube axis m is adhered. The metal sealing body 6 is fixed to the lower end part of the anode cylinder 10 in a vacuum airtight state. On the other hand, to the outer peripheral part of the output side pole piece 18, the lower end part of the almost-cylindrical metal sealing body 7 extending in the direction of the tube axis m is adhered. The metal sealing body 7 is fixed to the upper end part of the anode cylinder 10 in a vacuum airtight state.

To the lower end part of the input side metal sealing body 6, a ceramic stem 19 constituting the input unit 4 is joined in a vacuum airtight state. That is, the support rods 14, 15 planted on the ceramic stem 19 are connected to the cathode 3 by passing through the inside of the metal sealing body 6.

On the other hand, to the upper end part of the output side metal sealing body 7, a ceramic insulation tube 20 constituting the output unit 5 is joined in an airtight manner. To the upper end of the insulation tube 20, an exhaust tube 21 is joined in an airtight manner. Furthermore, an antenna 22 which is led from one of the plural vanes 11 penetrates the output side pole piece 18, passes through the inside of the metal sealing body 7, and extending to its upper end side. The tip of the antenna 22 is pinched with the exhaust tube 21 and fixed in an airtight state.

On the outside of the metal sealing bodies 6, 7, a pair of ring-shaped magnets 23, 24 is provided facing to each other as interposing the anode cylinder 10 in the direction of the tube axis m. The anode cylinder 10 and magnets 23, 24 are covered with a yoke 25: a solid magnetic circuit is formed by the pair of magnets 23, 24 and yoke 25.

Furthermore, a radiator 26 is provided between the anode cylinder 10 and the yoke 25. Radiant heat from the cathode 3 and heat loss of the oscillating unit 2 is transferred to the radiator 26 via the anode cylinder 10, and is released to the outside of the magnetron 1. The cathode 3 is connected to a filter circuit 27 having a coil and a lead-through capacitor via the support rods 14, 15. The filter circuit 27 is contained in a filter box 28. The outline of the configuration of the magnetron 1 is as the above.

### [2. Configuration of Output Unit]

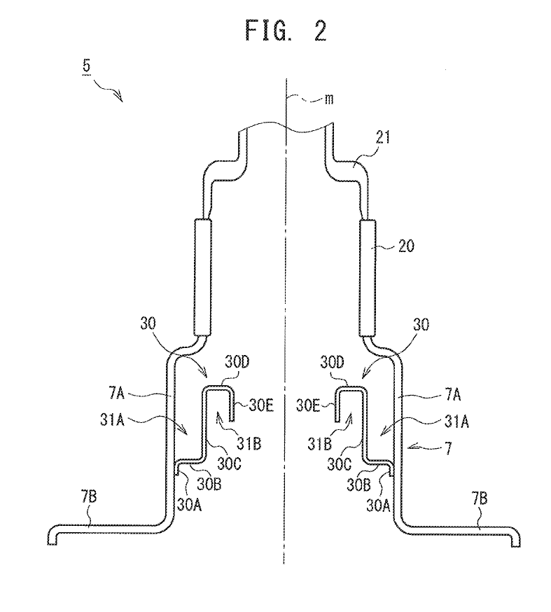

Next, the configuration of the output unit 5 of the magnetron 1 will be described in further detail with FIG. 2. Although FIG. 2 is an expanded sectional view of the output unit 5 of the magnetron 1, a part such as the antenna 22 is omitted for simplification of description.

As shown in FIG. 2, the output metal sealing body 7 is composed of a cylindrical part 7A having a cylindrical body and extending in the direction of the tube axis m, and a ring part 7B extending outward from the lower end of the cylindrical part 7A. Furthermore, the insulating cylinder 20 is joined to the upper end part of the cylindrical part 7A of the metal sealing body 7, and the exhaust tube 21 is joined to the upper end part of the insulating cylinder 20.

A bucket-shaped ring choke 30 having a cylindrical body and being a separated part from the metal sealing body 7 is joined to the inside of the cylindrical part 7A of the metal sealing body 7. The choke 30 is formed by: an outermost peripheral part 30A which is provided so that its central axis passes through the tube axis m, extends in the direction of the tube axis m and contacting with the inner surface of the cylindrical part 7A; a first ring-shaped part 30B extending inward from the upper end of the outermost peripheral part 30A perpendicularly to the direction of the tube axis m; a first cylindrical part 30C extending upward from the inner end of the first ring-shaped part 30B in parallel to the direction of the tube axis m; a second ring-shaped part 30D extending inward from the upper end of the first cylindrical part 30C perpendicularly to the direction of the tube axis m; and a second cylindrical part 30E extending downward from the inner end of the second ring-shaped part 30D in parallel to the direction of the tube axis m.

The first ring-shaped part 30B and second ring-shaped part 30D are in parallel to each other, and also the first cylindrical part 30C and second cylindrical part 30E are in parallel to each other. The respective lengths of the first ring-shaped part 30B and second ring-shaped part 30D in a diameter direction perpendicularly to the direction of the tube axis m are selected to prescribed lengths, and also those of the first cylindrical part 30C and second cylindrical part 30E in the direction of the tube axis m are selected to prescribed lengths.

Two choke grooves 31A, 31B are formed inside the metal sealing body 7 by the metal sealing body 7 and choke 30. Among these, the outside choke groove 31A is formed by the inner surface of the cylindrical part 7A of the metal sealing body 7, the first ring-shaped part 30B, and the first cylindrical part 30C; the inside choke groove 31b is formed by the first cylindrical part 30C, second ring-shaped part 30D, and second cylindrical part 30E.

The two choke grooves 31A, 31B are different in their lengths in the direction of the tube axis m (namely depth). That is, these choke grooves 31A, 31B are called ¼ wavelength type, and are formed so that their lengths (depths) in the direction of the tube axis m become ¼ of the wavelength of an arbitrary high frequency component aimed to suppress respectively. Thereby, the magnetron 1 can suppress two high frequency components of different frequencies by the two choke grooves 31A, 31B.

Here, a manufacturing process of the output unit 5 will be described. The metal sealing body 7 and choke 30 of the output unit 5 are formed by press formation from cold-rolling steel sheets. Specifically, the metal sealing body 7 is formed by press formation from a cold-rolling steel sheet with a thickness of e.g. 0.5 mm, and the choke 30 is with a thickness of e.g. 0.3 mm.

Copper (Cu) plating is applied to the inner wall of the metal sealing body 7 to form a Cu plating metal layer 7C as a first metal layer. Tin (Sn) plating that is cheaper and is lower in melting point than Cu plating is applied to the surface of the choke 30, to form a Sn plating metal layer 30F as a second metal layer. In this connection, the melting point of Cu is 1085 degrees C., and that of Sn is 232 degrees C. Furthermore, the choke 30 is fitted in the inside of the metal sealing body 7 from the lower side of the metal sealing body 7. Note that, to make the outermost peripheral part 30A of the choke 30 adhere to the inner surface of the cylindrical part 7A of the metal sealing body 7, it is formed so that the outer diameter of the choke 30 is slightly larger than (or equal to) for example the inner diameter of the cylindrical part 7A.

Next, as a brazing process, in the state where for example Ag—Cu brazing materials are sandwiched between the metal sealing body 7 and insulating cylinder 20 and between the insulating cylinder 20 and exhaust tube 21 respectively, these are inputted in a furnace, heated, and cooled, so that they are joined respectively. Note that, a heating temperature in the brazing process should be set to a temperature where Ag—Cu brazing materials melt (e.g. higher than 780 degrees C.).

At this time, the Cu plating metal layer 7C of the metal sealing body 7 and the Sn plating metal layer 30F of the choke 30 are adhered, so that the Sn plating of the choke 30 melts by a high temperature, and forming a eutectic state at a part of the adhering part of the Sn plating and Cu plating. And then, the eutectic state spreads over all the adhering part, and the part is Cu—Sn alloyed. That is, the metal sealing body 7 and choke 30 are electrically and mechanically joined equally to the case of brazing by brazing materials, by melting the adhering part of the Cu plating and Sn plating and becoming Cu—Sn alloy in the brazing process.

### [3. Conclusion and Effects]

As described thus far, in the magnetron 1 of this embodiment, the choke 30 for suppressing high frequency components is formed as a separated part from the output side metal sealing body 7, to apply Cu plating to the metal sealing body 7 and to apply Sn plating cheaper and lower in melting point than Cu plating to the choke 30. Furthermore, a brazing process for joining parts such as the metal sealing body 7, insulating cylinder 20, and exhaust tube 21 by brazing materials is performed in the state where the choke 30 is fitted in the inside of the metal sealing body 7.

At this time, the choke 30 is joined to the metal sealing body 7 equally to the case of using brazing materials, by that the adhered part of the Cu-plated metal sealing body 7 and the Sn-plated choke 30 melts and becomes a Cu—Sn alloy.

As the above, in the magnetron 1, a Cu plating layer on the metal sealing body 7 and a Sn plating layer on the choke 30 function not only as the original function of plating such as suppression of released gas and improvement of corrosion resistance, but as in place of brazing materials for joining the metal sealing body 7 and the choke 30. It is preferable that the thickness of the Cu plating metal layer is 1-15 μm and the thickness of the Sn plating metal layer is 3-15 μm.

Thereby, in the magnetron 1 there is no need to separately prepare brazing materials for joining the metal sealing body 7 and choke 30; it can reduce costs for brazing materials in comparison with conventional magnetrons in which a metal sealing body and a choke are joined by a brazing material. Furthermore, costs for brazing materials can be reduced to the same degree also in comparison with conventional magnetrons in which a metal sealing body and a choke are integrally molded.

Additionally, in the magnetron 1 Sn plating that is cheaper than Cu plating applied to the metal sealing body 7, is applied to the choke 30, so that plating costs can be reduced in comparison with conventional magnetrons in which a metal sealing body and a choke are integrally molded and Cu plating is applied thereto.

Moreover, in the magnetron 1, since the choke 30 is formed as a separated part from the metal sealing body 7, a plurality of choke grooves 31A, 31B can be provided inside the metal sealing body 7; a plurality of high frequency components having different frequencies can be suppressed by these plural choke grooves 31A, 31B. In addition to this, also it is possible to provide choke grooves 31A, 31B which have dimensions impossible to make by integral molding.

Furthermore, in the magnetron 1, since the choke grooves 31A, 31B can be formed only by the choke 30 being a single choke part, positioning of the choke part is easier than the magnetrons in which two choke grooves are formed with two choke parts, and plating costs can be reduced.

In this manner, according to the magnetron 1 of this embodiment, although a choke 30 is formed as a separated part from the metal sealing body 7, plating costs and brazing costs for the choke 30 can be reduced in comparison with conventional magnetrons; high frequency components can be effectively suppressed at lower costs in comparison with conventional magnetrons.

### [4. Other Embodiments]

### [4-1. Other Embodiment 1]

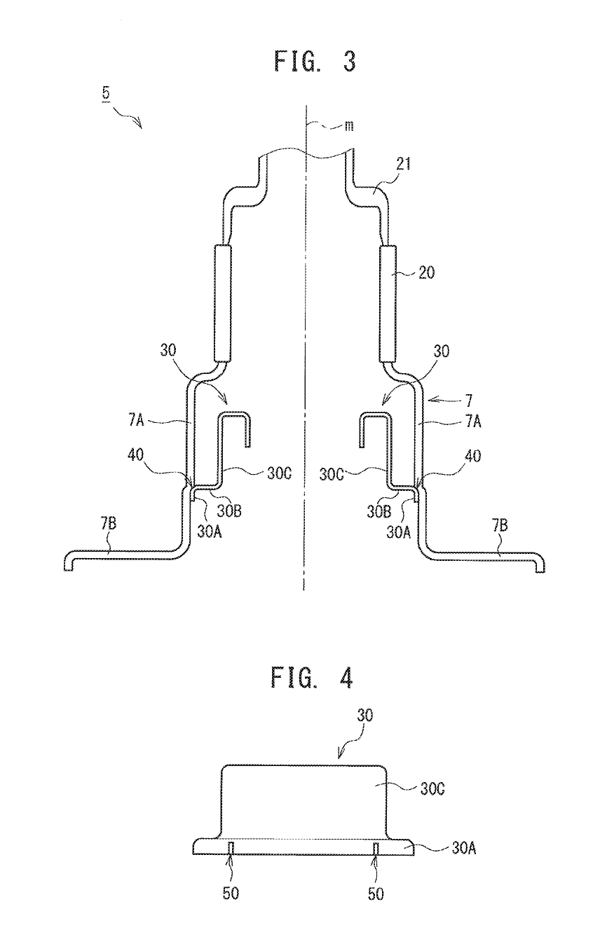

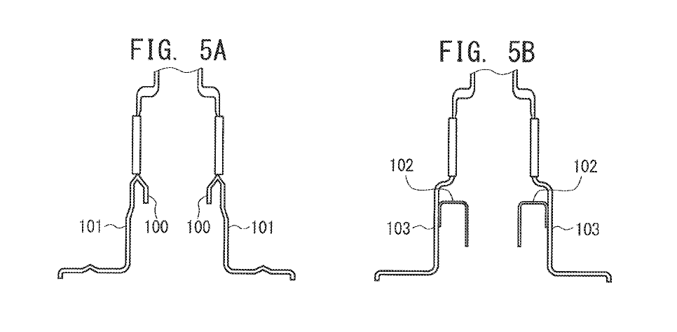

In the aforementioned embodiment, it is designed so that the choke 30 is fitted in the inside of the cylindrical part 7A of the output side metal sealing body 7. However, for example as shown in FIG. 3, the position of the choke 30 may be fixed (i.e. positioned) by providing a level difference 40 at a predetermined position in the direction of the tube axis m of the cylindrical part 7A of the metal sealing body 7, and when the choke 30 is being fitted in the inside of the cylindrical part 7A from the lower side of the metal sealing body 7, the corner parts of the outermost peripheral part 30A and first ring-shaped part 30B of the choke 30 are caught by the level difference 40.

In the aforementioned embodiment, it is designed so that the outer diameter of the choke 30 is slightly larger than (or equal to) for example the inner diameter of the cylindrical part 7A, to make the outermost peripheral part 30A of the choke 30 adhere to the inner surface of the cylindrical part 7A of the metal sealing body 7. For example as shown in FIG. 4, one or more than one slits 50 extending upward from the lower end in parallel to the direction of the tube axis m may be formed on the outermost peripheral part 30A of the choke 30. Thereby, the slit 50 absorbs the difference in size between the inner diameter of the cylindrical part 7A and the outer diameter of the choke 30, it enables the choke 30 easily fit in the metal sealing body 7 and enables the choke 30 adhere to the inner surface of the metal sealing body 7. Furthermore, in this case, the contact area between the metal sealing body 7 and the choke 30 becomes large; also an advantage such as reducing electric resistance can be obtained.

### [4-2. Other Embodiment 2]

In the aforementioned embodiment, it is designed so that the two choke grooves 31A, 31B are formed by the metal sealing body 7 and the choke 30 being a single choke part. However, the present invention is not only limited to this but three or more than three choke grooves may be formed or only one choke groove may be formed, by changing the number and the dimensions of cylindrical parts and ring-shaped parts constituting the choke 30.

In the aforementioned embodiment, as shown in FIG. 2, it is designed so that the outer choke groove 31A extends upward and the inner choke groove 31B extends downward. However, the present invention is not only limited to this but for example they may extend to the opposite directions respectively. In the aforementioned embodiment, it is designed so that the outermost peripheral part 30A of the choke 30 has a form extending downward from the outer end of the first ring-shaped part 30B. However, the present invention is not only limited to this but it may have a form extending upward from the outer end of the first ring-shaped part 30B.

Furthermore, in the aforementioned embodiment, it is designed so that the choke 30 being a single choke part is joined to the inside of the metal sealing body 7. However, the present invention is not only limited to this but by preparing plural chokes different in diameter (length in the direction of the tube axis m), these may be joined to mutually different positions inside the metal sealing body 7.

### [4-3. Other Embodiment 3]

In the aforementioned embodiment, it is designed so that the metal sealing body 7 and choke 30 are formed by press formation from cold-rolling steel sheets. As the above, it is desirable that the material of the metal sealing body 7 and choke 30 is the same but it may be different. In the case where the respective materials are different, it is desirable to select their materials so that the metal sealing body 7 has a smaller thermal expansion coefficient than the choke 30. Fe alloys such as SUS, 42 alloy, and Kovar can be used other than iron (Fe) for a metal sealing body and a choke.

For example, the material of the choke 30 may be changed to copper as the material of the metal sealing body 7 is a cold-rolling steel sheet. In this case, the metal sealing body 7 has a smaller thermal expansion coefficient than the choke 30, therefore, as these are inputted in a furnace and their temperatures rise, adhesion between the choke 30 and metal sealing body 7 increases; more excellent joining can be performed. In this case, it is also possible to obtain an advantage in manufacturing that so high precision is unnecessary about the outer diameter dimension of the choke 30.

### [4-4. Other Embodiment 4]

In the aforementioned embodiment, Cu plating formed of Cu as a first material is applied to the metal sealing body 7, and Sn plating formed of Sn as a second material is applied to the choke 30. Not only limited to this, in a brazing process for joining parts such as the insulating cylinder 20 and exhaust tube 21 by brazing materials, a different material from Cu plating and Sn plating may be applied to the metal sealing body 7 and choke 30 as long as a condition that adhesion parts are melted and become an alloy is satisfied. For example as another embodiment, nickel (Ni) plating and Cu—Ni alloy plating can be used as the above first metal layer.

Additionally, it is desirable that the second metal layer being a plating layer applied to the choke 30 has a lower melting point than the plating applied to the metal sealing body 7 and has a lower melting point than a brazing material for joining the parts such as the metal sealing body 7, insulating cylinder 20, and exhaust tube 21. For example, Sn alloy plating having a lower melting point than the first metal layer e.g. Sn—Cu, Sn—Ag—Cu, and Cu—Ag alloy plating can be applied other than Sn.

Additionally, these metal layers are not only limited to a single layer construction but may be formed in a multilayer construction.

### [4-5. Other Embodiment 5]

Furthermore, in the aforementioned embodiment, it has explained joining of the metal sealing body 7 and choke 30 of the magnetron 1, however, parts other than the metal sealing body 7 and choke 30 may have a different constitution from that of the aforementioned magnetron 1.

### EXPLANATION OF REFERENCE SYMBOLS

1: magnetron

2: oscillating unit

3: cathode

4: input unit

5: output unit

6, 7, 101, 103: metal sealing body

20: insulating cylinder

21: exhaust tube

22: antenna

30, 100, 102: choke

31A, 31B: choke groove

40: level difference

50: slit

1. A magnetron provided with a cylindrical metal choke for suppressing higher harmonic waves on the inside of a cylindrical metal sealing body provided on the output unit side of an anode cylinder, comprising:
a first metal layer plated on the inner wall of the metal sealing body; and
a second metal layer plated on the surface of the metal choke and different in melting point from the first metal layer;
the magnetron wherein an alloy layer of the first metal layer and the second metal layer is formed at the joined part of the metal sealing body and metal choke.

2. The magnetron according to claim 1, characterized in that the melting point of the second metal layer is lower than the melting point of the first metal layer.

3. The magnetron according to claim 2, characterized in that the first metal layer is copper (Cu) or nickel (Ni) and the second metal layer is tin (Sn) or Sn alloy.

4. The magnetron according to claim 3, characterized in that the metal sealing body is iron (Fe) or iron alloy, the first metal layer is copper (Cu), the metal choke is iron (Fe) or iron alloy, and the second metal layer is tin (Sn).

5. The magnetron according to claim 3, characterized in that the metal sealing body is iron (Fe) or iron alloy, the first metal layer is copper (Cu), the metal choke is copper (Cu) or copper alloy, and the second metal layer is tin (Sn).

6. The magnetron according to claim 1, characterized in that one end surface of the metal sealing body is welded to the anode cylinder, the other end surface is brazed to an insulating cylinder disposed on its output unit side with a brazing material, and the melting point of the second metal layer of the metal choke is lower than the melting point of the brazing material.

7. The magnetron according to claim 6, characterized in that the brazing material is Ag—Cu alloy and the alloy layer of the first metal layer and the second metal layer is Cu—Sn alloy.

8. The magnetron according to claim 1, characterized in that a level difference is provided on the inside of the metal sealing body to fix the position of the metal choke.

9. The magnetron according to claim 1, characterized in that the thermal expansion coefficient of the metal choke is smaller than the thermal expansion coefficient of the metal sealing body.

10. The magnetron according to claim 1, characterized in that a first choke groove is formed between the metal choke and the metal sealing body and a second choke groove is formed on the metal choke.
